(19) United States
(12) Patent Application Publication
(10) Pub. No.: US 2025/0227498 A1
(43) Pub. Date: Jul. 10, 2025

(54) TERMINAL, RADIO COMMUNICATION METHOD, AND BASE STATION

(71) Applicant: NTT DOCOMO, INC., Tokyo (JP)

(72) Inventors: Haruhi Echigo, Tokyo (JP); Hiroki Harada, Tokyo (JP); Masato Taniguchi, Tokyo (JP); Tianyang Min, Tokyo (JP); Souki Watanabe, Tokyo (JP); Takumi Fujitsuka, Tokyo (JP); Yazhuo Guan, Beijing (CN); Issei Nakamura, Beijing (CN); Liu Liu, Beijing (CN)

(73) Assignee: NTT DOCOMO, INC., Tokyo (JP)

(21) Appl. No.: 18/853,627

(22) PCT Filed: Apr. 13, 2022
(86) PCT No.: PCT/JP2022/017734

§ 371 Date: Oct. 2, 2024

(51) Int. Cl. H04W 24/02; H04L 41/16; H04W 28/06

(52) U.S. Cl. CPC H04W 24/02; H04L 41/16; H04W 28/06

(57) ABSTRACT

A terminal according to an aspect of the present disclosure includes a receiving section that receives network (NW)-trained model information related to a model trained by a network (NW-trained model) and reference model information related to a reference model that is a base of the NW-trained model, and a control section that judges the NW-trained model, based on the NW-trained model information and the reference model information. According to an aspect of the present disclosure, preferable overhead reduction/channel estimation/resource use can be achieved.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication technologies, it is studied to utilize the artificial intelligence (AI) technology, such as machine learning (ML), for control, management, and the like of networks/devices.

It is preferable to appropriately control AI model training/model inference in a terminal (user terminal, User Equipment (UE)). However, study about concrete contents of the control has not been advanced yet. Unless the control is appropriately defined, appropriate overhead reduction/highly accurate channel estimation/highly efficient resource use cannot be achieved, which may suppress improvement of communication throughput/communication quality.

Thus, an object of the present disclosure is to provide a terminal, a radio communication method, and a base station capable of achieving preferable overhead reduction/channel estimation/resource use.

### Solution to Problem

A terminal according to an aspect of the present disclosure includes a receiving section that receives network (NW)-trained model information related to a model trained by a network (NW-trained model) and reference model information related to a reference model that is a base of the NW-trained model, and a control section that judges the NW-trained model, based on the NW-trained model information and the reference model information.

### Advantageous Effects of Invention

According to an aspect of the present disclosure, preferable overhead reduction/channel estimation/resource use can be achieved.

### BRIEF DESCRIPTION OF DRAWINGS

FIG. 1 is a diagram to show an example of an AI model management framework.

FIG. 2 is a diagram to show an example of an AI model.

FIG. 3 is a diagram to show an example of indication of an AI model according to a first embodiment.

FIG. 4 is a diagram to show an example of update of the AI model according to the first embodiment.

FIG. 5 is a diagram to show an example of fine tuning.

FIG. 6 is a diagram to show an example of transfer learning.

FIG. 7 is a diagram to show an example of update of the AI model according to the first embodiment.

FIG. 8 is a diagram to show an example of indication of an AI model according to a second embodiment.

FIG. 9 is a diagram to show an example of update of the AI model according to the second embodiment.

FIG. 10 is a diagram to show an example of update of the AI model according to the second embodiment.

FIG. 11 is a diagram to show an example of indication of an AI model according to a third embodiment.

FIG. 12 is a diagram to show an example of indication of the AI model according to the third embodiment.

FIGS. 13A and 13B are diagrams to show examples of UE-trained AI model information according to the third embodiment.

FIGS. 14A and 14B are diagrams to show examples of the UE-trained AI model information according to the third embodiment.

FIG. 15 is a diagram to show an example of exchange of AI model information for federated learning.

FIGS. 16A to 16C are diagrams to show an example of updated AI model information.

FIGS. 17A and 17B are diagrams to show an example of learning using knowledge distillation.

FIG. 18 is a diagram to show an example of a schematic structure of a radio communication system according to one embodiment.

FIG. 19 is a diagram to show an example of a structure of a base station according to one embodiment.

FIG. 20 is a diagram to show an example of a structure of a user terminal according to one embodiment.

FIG. 21 is a diagram to show an example of a hardware structure of the base station and the user terminal according to one embodiment.

FIG. 22 is a diagram to show an example of a vehicle according to one embodiment.

### DESCRIPTION OF EMBODIMENTS

### (Application of Artificial Intelligence (AI) Technology to Radio Communication)

For future radio communication technologies, a study is underway to utilize the AI technology, such as machine learning (ML), for control, management, and the like of networks/devices.

For example, for the future radio communication technologies, a study is underway to utilize the AI technology for improvement in channel state information (Channel State Information Reference Signal (CSI)) feedback (for example, overhead reduction, accuracy enhancement, prediction), enhancement in beam management (for example, accuracy enhancement, prediction in time/spatial domain), enhancement in location measurement (for example, location estimation/prediction enhancement), and the like.

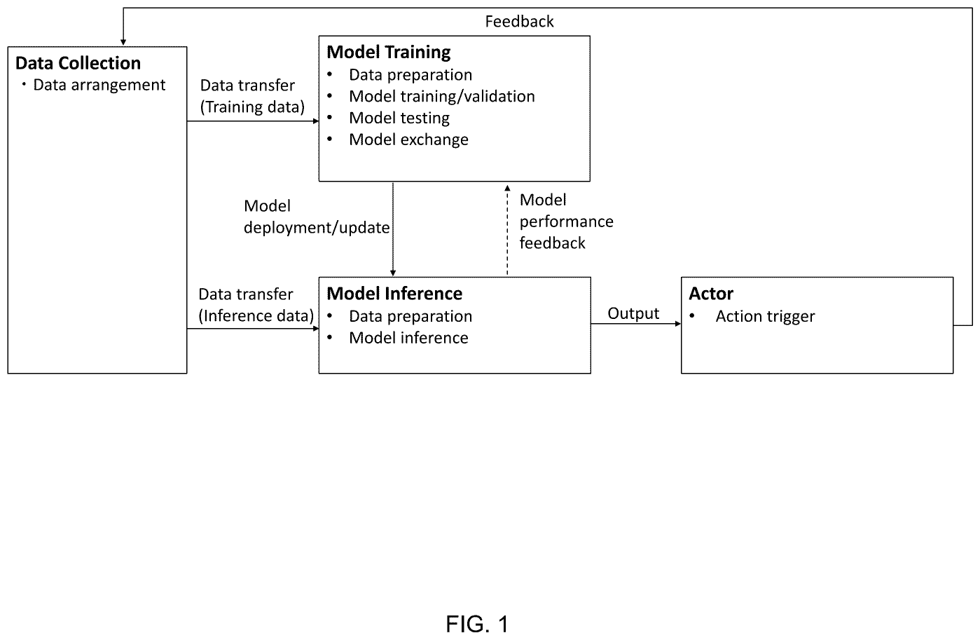

FIG. 1 is a diagram to show an example of an AI model management framework. In the present example, stages related to an AI model are shown using blocks. The present example is also expressed as AI model life cycle management.

A data collection stage corresponds to a stage to collect data for generating/updating the AI model. The data collection stage may include data arrangement (for example, determining which data is forwarded for model training/model inference), data forwarding (for example, forwarding data to an entity (for example, UE, gNB) performing model training/model inference), and the like.

A model training stage is to perform the model training, based on data (training data) forwarded from the collection stage. This stage may include data preparation (for example, performing preprocessing, cleaning, formatting, conversion, and the like of data), model training/validation, model testing (for example, checking whether a trained model meets a performance threshold), model exchange (for example, forwarding a model for distributed learning), model deployment/update (deploying/updating a model for an entity performing model inference), and the like.

A model inference stage is to perform model inference, based on the data (inference data) forwarded from the collection stage. This stage may include data preparation (for example, performing preprocessing, cleaning, formatting, conversion, and the like of data), model inference, model performance feedback (feeding back model performance to an entity performing model training), output (providing a model output to an actor), and the like.

An actor stage may include an action trigger (for example, determining whether to trigger action to another entity), feedback (for example, feeding back information required for training data/inference data/performance feedback), and the like.

Note that, for example, training of a model for mobility optimization may be performed in, for example, maintenance, operation, and administration in a network (NW) (Operation, Administration and Maintenance (Management))/gNodeB (gNB). In the former case, interoperation, large amounts of storage, operator manageability, model flexibility (such as feature engineering) are advantageous. In the latter case, model update latency, data exchange for model deployment, and the like are advantageously not required. The inference of the model described above may be performed in the gNB, for example.

The entity performing training/inference may differ depending on a use case.

For example, for AI-aided beam management based on a measurement report, the OAM/gNB may perform the model training, and the gNB may perform the model inference.

For AI-aided UE-assisted positioning, a Location Management Function (LMF) may perform the model training, and the LMF may perform the model inference.

For CSI feedback/channel estimation using an autoencoder, the OAM/gNB/UE may perform the model training, and the gNB/UE may perform the model inference (jointly).

For AI-aided beam management or AI-aided UE-based positioning based on beam measurements, the OAM/gNB/UE may perform the model training, and the UE may perform the model inference.

As describe above, it is preferable to perform training of an AI model in the UE. This is because the UE may directly acquire data which the gNB/OAM cannot directly use. For example, the model training of the autoencoder for the CSI feedback requires complete downlink CSI information (or channel information), but the UE only can directly acquire this information.

If the model training of the autoencoder is performed in the gNB/OAM, the UE needs to transmit the complete downlink CSI information (or channel information), but a communication overhead is large. On the other hand, if the model training of the autoencoder is performed in the UE, the UE needs to maintain the complete downlink CSI information (or channel information), but a storage/computation resource of the UE is scarcer than that of the gNB/OAM.

From the above description, it is preferable to appropriately control the model training/model inference in the UE. However, study about concrete contents of the control has not been advanced yet. Unless this control is appropriately defined, appropriate overhead reduction/highly accurate channel estimation/highly efficient resource use cannot be achieved, which may suppress improvement of communication throughput/communication quality.

Thus, the inventors of the present invention came up with the idea of a preferable method for controlling the model training/model inference. Note that each of the embodiments of the present disclosure may be applied when AI/prediction is not used.

In one embodiment of the present disclosure, a terminal (user terminal, User Equipment (UE))/base station (BS) performs training of an ML mode in a training mode, and performs an ML model in inference mode (also referred to as inference mode or the like). In the inference mode, validation of the accuracy of the ML model trained in the training mode (trained ML model) may be performed.

In the present disclosure, the UE/BS may input channel state information, a reference signal measurement value, and the like to the ML model and output highly accurate channel state information/measured value/beam selection/location, future channel state information/radio link quality, and the like.

Note that, in the present disclosure, AI may be interpreted as an object (also referred to as a target, data, function, program, and the like) having (implementing) at least one of the following features:
estimation based on observed or collected information,
selection based on observed or collected information, and
prediction based on observed or collected information.

In the present disclosure, the object may be, for example, an apparatus, a device, or the like, such as a terminal or a base station. In the present disclosure, the object may correspond to a program/model/entity operating in the apparatus.

Note that, in the present disclosure, the ML model may be interpreted as an object having (implementing) at least one of the following features:
feeding information to thereby generate an estimated value,
feeding information to thereby predict an estimated value,
feeding information to thereby find a feature, and
feeding information to thereby select an operation.

In the present disclosure, an ML model, a model, an AI model, predictive analytics, a predictive analytics model, and the like may be interchangeably interpreted. The ML model may be derived by using at least one of regression analysis (for example, linear regression analysis, multiple regression analysis, logistic regression analysis), support vector machine, random forest, neural network, deep learning, and the like. In the present disclosure, a model may be interpreted as at least one of an encoder, a decoder, a tool, and the like.

The ML model outputs at least one piece of information among an estimated value, a predicted value, a selected operation, classification, and the like, based on the input information.

Examples of the ML model may include supervised learning, unsupervised learning, and reinforcement learning. The supervised learning may be used to perform learning of a general rule for mapping an input to an output. The unsupervised learning may be used to perform learning of characteristics of data. The reinforcement learning may be used to perform learning of operation for maximizing a goal.

In the present disclosure, generation, computation, derivation, and the like may be interchangeably interpreted. In the present disclosure, “perform,” “manage,” “operate,” “carry out,” and the like may be interchangeably interpreted. In the present disclosure, training, learning, update, retraining, and the like may be interchangeably interpreted. In the present disclosure, inference, after-training, substantial use, actual use, and the like may be interchangeably interpreted. A signal may be interpreted as a signal/channel and vice versa.

In the present disclosure, the training mode may correspond to a mode in which a UE/BS transmits/receives a signal for an ML model (in other words, an operation mode in a training period). In the present disclosure, the inference mode may correspond to a mode in which a UE/BS performs an ML model (for example, performs a trained ML model to predict an output) (in other words, an operation mode in an inference period).

In the present disclosure, the training mode may refer to a mode in which, as a specific signal to be transmitted in the inference mode, the specific signal with high overhead (for example, a large resource amount) is transmitted.

In the present disclosure, the training mode may refer to a mode in which a first configuration (for example, a first DMRS configuration, a first CSI-RS configuration, a first CSI report configuration) is referred to. In the present disclosure, the inference mode may refer to a mode in which a second configuration (for example, a second DMRS configuration, a second CSI-RS configuration, a second CSI report configuration), which is different from the first configuration, is referred to. In the first configuration, a larger number of at least one of time resources, frequency resources, coding resources, ports (antenna ports) related to measurement than those in the second configuration may be configured. Note that, for example, the CSI report configuration may include a configuration related to the autoencoder.

Embodiments according to the present disclosure will be described in detail with reference to the drawings as follows. The radio communication methods according to respective embodiments may each be employed individually, or may be employed in combination.

In the following embodiments, description will be given of an ML model related to UE-BS communication, and hence related subjects are a UE and a BS. However, application of each of the embodiments of the present disclosure is not limited to this. For example, for communication between different subjects (for example, UE-UE communication), the UE and the BS in the following embodiments may be interpreted as a first UE and a second UE. In other words, the UE, the BS, and the like in the present disclosure may be interpreted as any UE/BS.

In the present disclosure, “A/B” and “at least one of A and B” may be interchangeably interpreted. In the present disclosure, “A/B/C” may refer to “at least one of A, B, and C.”

In the present disclosure, “activate,” “deactivate,” “indicate,” “select,!” “configure,!” “update,!” “determine,!” and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (R4SI)), other system information (OSI), or the like.

In the present disclosure, physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, a CSI-RS, a non zero power (NZP) CSI-RS, a zero power (ZP) CSI-RS, and CSI interference measurement (CSI-IM) may be interchangeably interpreted. The CSI-RS may include other reference signals.

In the present disclosure, a measured/reported RS may mean an RS measured/reported for CSI reporting.

In the present disclosure, timing, a time point, a time, a slot, a sub-slot, a symbol, a subframe, and the like may be interchangeably interpreted.

In the present disclosure, a direction, an axis, a dimension, a domain, a polarized wave, a polarization component, and the like may be interchangeably interpreted.

In the present disclosure, the RS may be a CSI-RS, an SS/PBCH block (SS block (SSB)), or the like, for example. An RS index may be a CSI-RS resource indicator (CRI), an SS/PBCH block resource indicator (SSBRI), or the like.

In the present disclosure, estimation, prediction, and inference may be interchangeably interpreted. In the present disclosure, “estimate,” “predict,” and “infer” may be interchangeably interpreted.

In the present disclosure, an autoencoder, an encoder, a decoder, or the like may be interpreted as at least one of a model, an ML model, a neural network model, an AI model, an AI algorithm, and the like. The autoencoder may be interchangeably interpreted as an arbitrary autoencoder such as a stacked autoencoder and a convolutional autoencoder. The encoder/decoder in the present disclosure may adopt a model of Residual Network (ResNet), DenseNet, RefineNet, or the like.

In the present disclosure, an encoder, encoding, encode, modification/change/control by an encoder, and the like may be interchangeably interpreted. In the present disclosure, a decoder, decoding, decode, modification/change/control by a decoder, and the like may be interchangeably interpreted.

In the present disclosure, the channel measurement/estimation may be performed by using at least one of a channel state information reference signal (CSI-RS), a synchronization signal (SS), a synchronization signal/broadcast channel (Synchronization Signal/Physical Broadcast Channel (SS/PBCH)) block, a demodulation reference signal (DMRS), a reference signal for measurement (Sounding Reference Signal (SRS)), and the like, for example.

In the present disclosure, the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in Layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), and the like.

In the present disclosure, UCI, CSI reporting, CSI feedback, feedback information, feedback bit, and the like may be interchangeably interpreted. In the present disclosure, a bit, a bit string, a bit sequence, a sequence, a value, information, a value obtained from a bit, information obtained from a bit, and the like may be interchangeably interpreted.

In the present disclosure, a layer (for an encoder) may be interchangeably interpreted as a layer (input layer, intermediate layer) used in an AI model. The layer in the present disclosure may correspond to at least one of an input layer, an intermediated layer, an output layer, a batch normalization layer, a convolutional layer, an activation layer, a dense layer, a normalization layer, a pooling layer, an attention layer, a dropout layer, a fully-connected layer, and the like.

### (Radio Communication Method)

In the present disclosure, AI model information may refer to information including at least one of the following:
information of an input/output of an AI model,
information of preprocessing/post-processing for an input/output of an AI model,
information of parameters of an AI model,
training information for an AI model,
inference information for an AI model, and
performance information related to an AI model.

Here, the information of an input/output of AI model may refer to information including at least one of the following:
Contents of input/output data (for example, RSRP, SINR, amplitude/phase information in a channel matrix (or precoding matrix), information related to an angle of arrival (AoA), information related to an angle of departure (AoD), location information),
a type of input/output data (for example, an immutable value, a floating-point value),
a quantization interval of input/output data (a quantization step size) (for example, 1 dBm for L1-RSRP), and
a possible range of input/output data (for example, [0, 1]).

Note that in the present disclosure, the information related to the AoA may include information related to at least one of an azimuth angle of arrival and a zenith angle of arrival (ZoA). The information related to the AoD may include information related to at least one of, for example, an azimuth angle of departure and a zenith angle of departure (ZoD).

In the present disclosure, the location information may be location information related to the UE/NW. The location information may include at least one of information (for example, a latitude, a longitude, or an altitude) obtained by using a positioning system (for example, satellite positioning system (such as Global Navigation Satellite System (GNSS) and Global Positioning System (GPS)), information of a base station adjacent to the UE (or a serving base station) (for example, an identifier (ID) of the base station/cell, a distance between the BS and the UE, a direction/angle of the BS (UE) when viewed from the UE (BS), coordinates of the BS (UE) when viewed from the UE (BS) (for example, the X/Y/Z-axis coordinates) or the like), a specific address (for example, an Internet Protocol (IP) address) of the UE, and the like. The location information of the UE is not limited to information with reference to the position of the BS and may be information with reference to a specific point.

The location information may include information related to the implementation of the UE itself (for example, the location (position)/direction of an antenna, the location/direction of an antenna panel, the number of antennas, the number of antenna panels, or the like).

The location information may include mobility information. The mobility information may include information indicating at least one of information indicating a mobility type, a moving speed of the UE, an acceleration of the UE, a moving direction of the UE, and the like.

Here, the mobility type may correspond to at least one of fixed location UE, movable/moving UE, no mobility UE, low mobility UE, middle mobility UE, high mobility UE, cell-edge UE, not-cell-edge UE, and the like.

The information of preprocessing/post-processing for an input/output of an AI model described above may include information related to at least one of the following:
whether to apply normalization (for example, Z score normalization (standardization), minimum-maximum (min-max) normalization),
parameters for normalization (for example, a mean/variance for Z score normalization, a minimum/maximum value for min-max normalization),
whether to apply a specific numerical inversion method (for example, one hot encoding, label encoding, and the like), and
a selection rule whether to be used as training data.

For example, the Z score normalization as the preprocessing may be performed on input information x to obtain normalized input information x_{new} (x_{new}=(x−μ)/σ, where μ represents a mean of x, σ represents a standard deviation) and the obtained normalized input information x_{new} may be input to an AI model, and the post-processing may be performed on an output yₒᵤₜ from the AI model to obtained a final output y.

The information of parameters of an AI model described above may include information related to at least one of the following:
weight (for example, a coefficient (coupling coefficient) of a neuron) information in an AI model,
a structure of an AI model,
a type of an AI model as a model component (for example, Residual Network (ResNet), DenseNet, RefineNet, a transformer model, CRBlock, a recurrent neural network (RNN), a long short-term memory (LSTM), a gated recurrent unit (GRU)), and
a function of an AI model as a model component (for example, decoder, encoder).

Note that the weight information in an AI model may include information related to at least one of the following:
a bit width (size) of the weight information,
a quantization interval of the weight information,
a possible range of the weight information,
parameters of a weight in an AI model,
information of a difference from a pre-updated AI model (in a case of updating) and,
a weight initialization method (for example, zero-initialization, random initialization (based on normal distribution/uniform distribution/truncated normal distribution), Xavier initialization (for sigmoid function), He initialization (for rectified linear units (ReLU)).

The structure of an AI model described above may include information related to at least one of the following:
the number of layers,
a type of a layer (for example, a convolutional layer, an activation layer, a dense layer, a normalization layer, a pooling layer, an attention layer),
layer information,
time series-specific parameters (for example, bidirectionality, time step), and
parameters of training (for example, a type of a function (L2 regularization, dropout function, and the like), where to arrange this function (for example, after which layer)).

The layer information may include information related to at least one of the following:
the number of neurons in each layer.
a kernel size,
a stride for pooling layer/convolutional layer,
a pooling method (MaxPooling, AveragePooling, and the like),
information of a residual block,
the number of heads,
a normalization method (batch normalization, instance normalization, layer normalization, and the like), and
an activation function (sigmoid, tanh function, ReLU, leaky ReLU information, Maxout, Softmax).

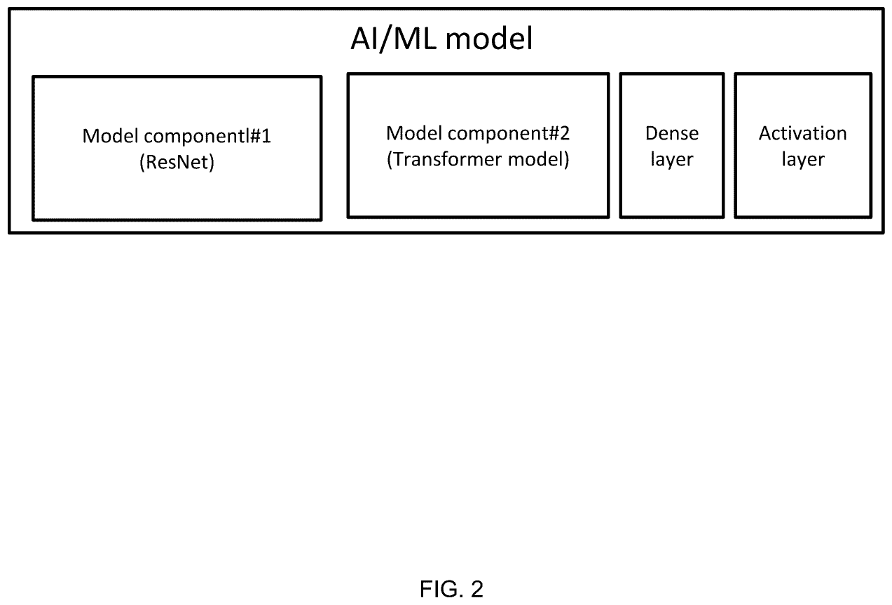

FIG. 2 is a diagram to show an example of an AI model. The present example shows an AI model including a ResNet that is model component #1, a transformer model that is model component #2, a dense layer, and a normalization layer. As described above, an AI model may be included as a component of another AI model. Note that FIG. 2 may show the AI model in which processing proceeds left to right.

Training information for the above AI model may include information related to at least one of the following:
information for an optimization algorithm (for example, a kind of optimization (stochastic gradient descent (SGD)), AdaGrad, Adam, and the like), parameters for optimization (learning rate, momentum information, and the like),
information of a loss function (for example, information related to a loss function indexes (metrics) (mean absolute error (MAE)), mean square error (MSE), a cross-entropy loss, NLLLoss, KL divergence, and the like),
parameters to be frozen for training (for example, a layer, a weight),
parameters to be updated (for example, a layer, a weight),
parameters to be initial parameters (to be used as initial parameters) for training (for example, a layer, a weight), and
a method of training/updating an AI model (for example, the (recommended) number of epochs, a batch size, the number of data used for training).

The inference information for an AI model described above may include information related to decision tree branch pruning, parameter quantization, and the like.

The performance information related to an AI model descried above may include information related to an expected value of a loss function defined for the AI model.

The AI model information related to a specific AI model may be predefined in a standard, or the UE may be notified of the AI model information from a network (NW). The AI model defined in a standard may be referred to as a reference AI model. The AI model information related to the reference AI model may be referred to as reference AI model information.

Note that the AI model information in the present disclosure may include an index for specifying an AI model (which may be referred to as an AI model index, for example). The AI model information in the present disclosure may include the AI model index in addition to/instead of the information of an input/output of an AI model described above. Association of the AI model index with the AI model information (for example, the information of an input/output of an AI model) may be predefined in a standard, or the UE may be notified of the association from the NW.

### First Embodiment

A first embodiment relates to controlling the use of a reference AI model.

A UE may receive reference AI model information from an NW. The UE may deploy (enable) the reference AI model, based on the received reference AI model information.

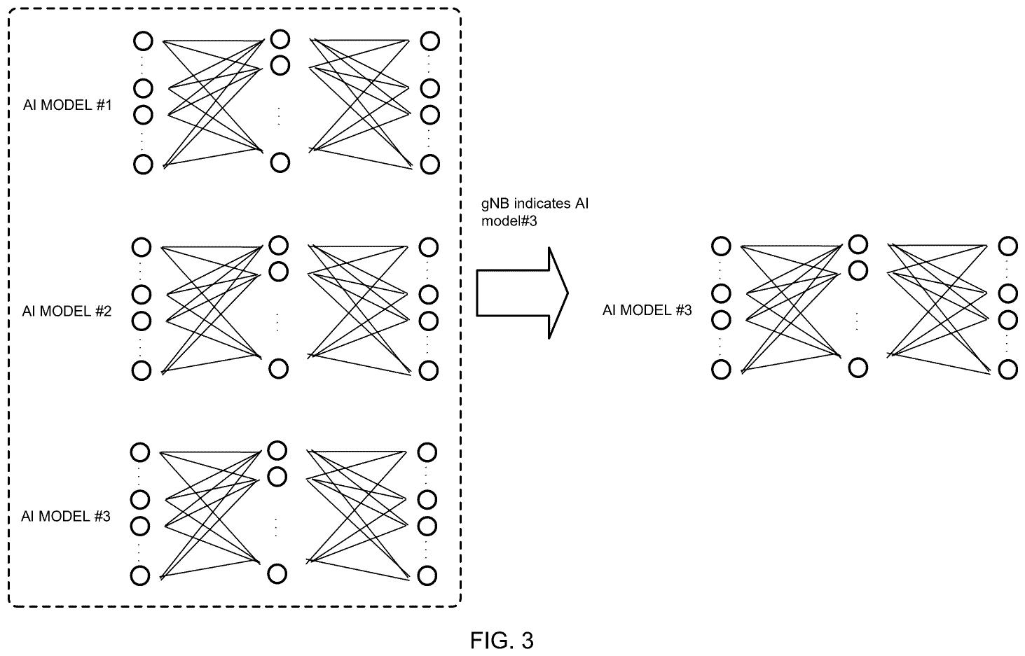

FIG. 3 is a diagram to show an example of indication of an AI model according to the first embodiment. In the present example, AI models #1 to #3 are defined in the standards. The UE receiving the AI model information indicating AI model #3 from the NW may deploy AI model #3.

The UE may use, for inference, a reference AI model without change based on (for example, indicated by) the receive reference AI model information.

The UE may train the reference AI model, based on the received reference AI model information.

Note that in the present disclosure, the training/update of the AI model in the UE may be performed based on data set owned by the UE (for example, data obtained from a measurement result).

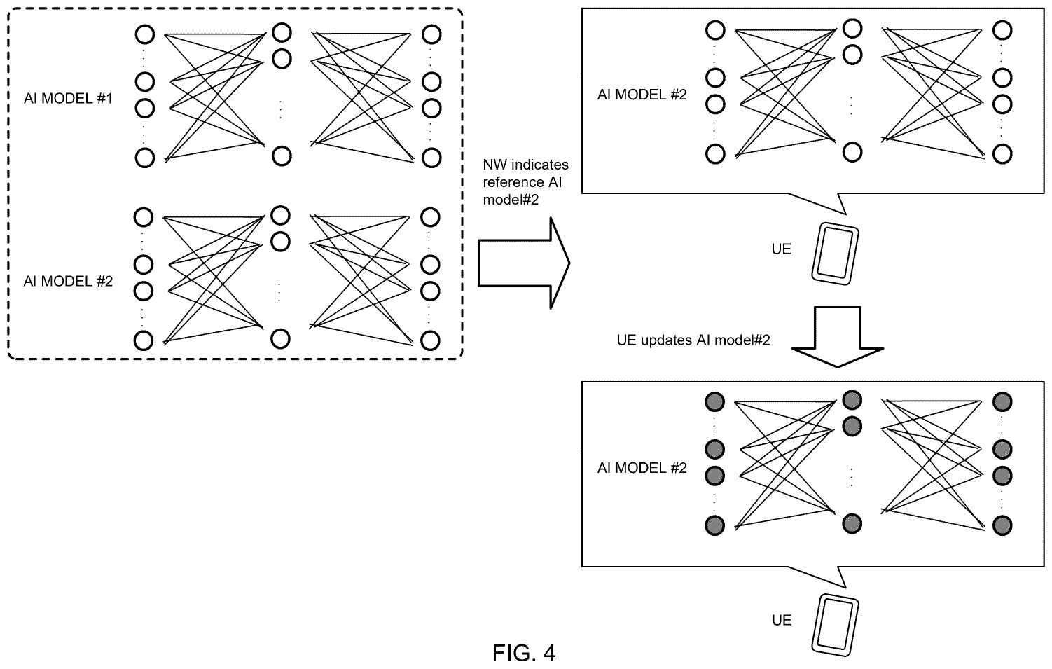

FIG. 4 is a diagram to show an example of the update of the AI model according to the first embodiment. In the present example, AI models #1 and #2 are defined in the standards. The UE receiving the AI model information indicating AI model #2 from the NW may deploy AI model #2. The UE may update relevant AI model #2.

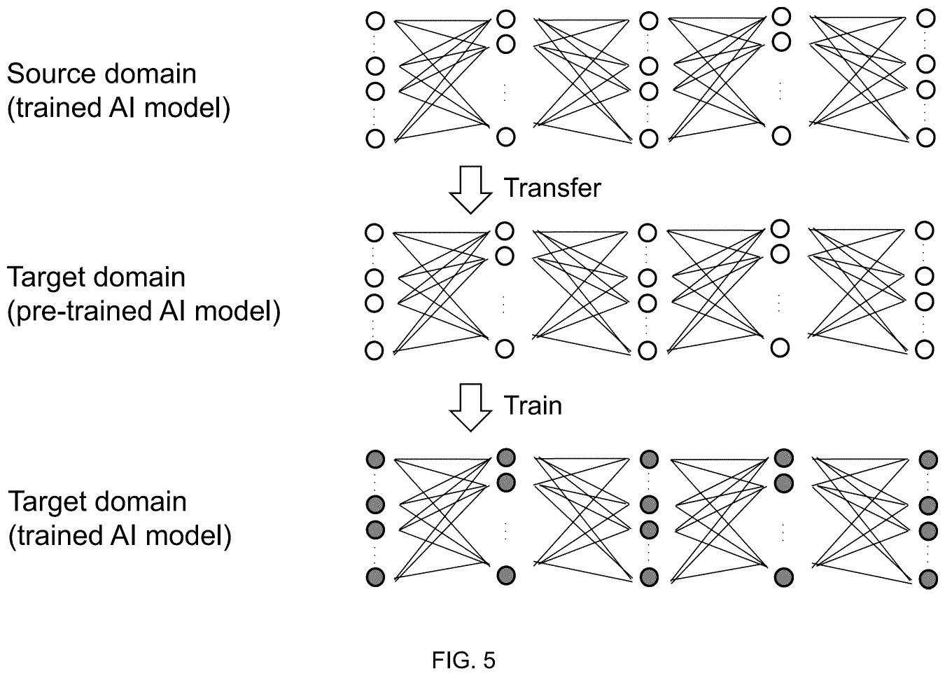

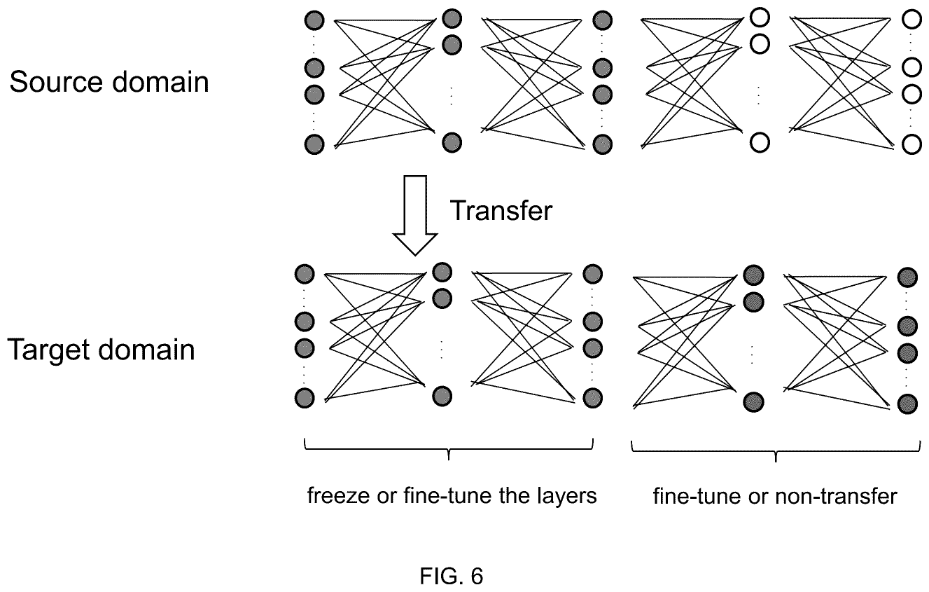

Here, for the update of the AI model, fine tuning and transfer learning are described. FIG. 5 is a diagram to show an example of the fine tuning. FIG. 6 is a diagram to show an example of the transfer learning.

As shown in FIG. 5, in the fine tuning, an entity performing training uses parameters for a trained AI model in a source domain as initial parameters for an AI model (pre-trained AI model) in a target domain to perform the training, and derives a trained AI model in the target domain. That is, all layers of the trained AI model in the source domain may be forwarded to all layers of the AI model in the target domain, or part of the layers may not be updated and used without change (or may be fixed (frozen)).

As shown in FIG. 6, in the transfer leaning (which may be referred to as network-based deep transfer leaning, or the like), the entity performing training reuses part of the trained layers in the source domain for layers in the target domain. These layers (front (left part) layers in the figure) may be used as a feature extractor. That is, only part of the layers of the trained AI model in the source domain may be forwarded to the corresponding layers of the AI model in the target domain, or the part of the layers may be fixed (frozen) or fine-tuned. Remaining layers in the target domain may have no layer corresponding to the source domain, or may be newly trained (or fine-tuned) in the target domain.

The UE need not update, in the training, parameters (for example, a layer, a weight) to be frozen for training which are obtained from the reference AI model information. The UE may update, in the training, parameters to be updated (fine-tuned) which are obtained from the reference AI model information.

The UE may perform the training by using parameters to be the initial parameters (to be used as the initial parameters) for training which are obtained from the reference AI model information.

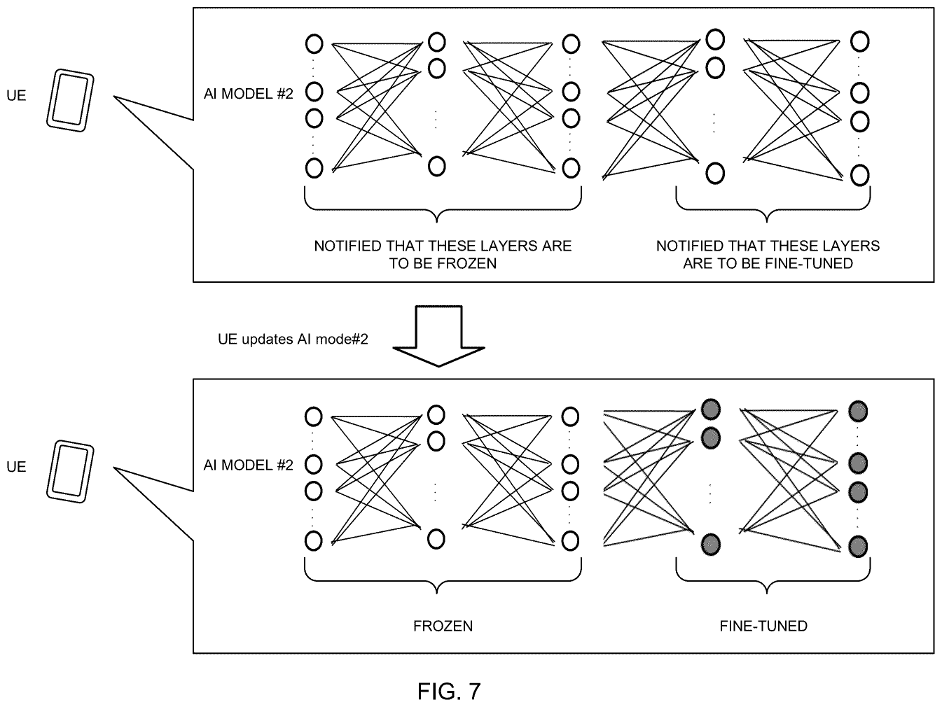

FIG. 7 is a diagram to show an example of the update of the AI model according to the first embodiment. In the present example, the UE is indicated to update reference AI model #2 from the NW. However, the indication include information indicating that first three layers are to be frozen, and last two layers are to be fine-tuned. The UE may derive updated AI model #2 in which the first three layers of reference AI model #2 are frozen and the last two layers are fin-tuned based on the indication.

According to the first embodiment described above, the reference AI model can be appropriately used in the UE.

### Second Embodiment

A second embodiment relates to controlling the use of an AI model trained by an NW (hereinafter, also referred to as an NW-trained AI model).

The NW may train the reference AI model. The NW may transmit AI model information related to the trained reference AI model (in other words, the NW-trained AI model) to a UE. The AI model information may be referred to as NW-trained AI model information.

The UE may receive the reference AI model information that is a base of the NW-trained AI model information from the NW. The UE may receive the NW-trained AI model information from the NW. The NW-trained AI model information may include, instead of or in addition to the AI model information already described, information of any or a combination of the following:
(an index of) the reference AI model that is the base of the NW-trained AI model and
information of a difference of the NW-trained AI model from the reference AI model.

The UE may deploy (enable) the NW-trained AI model, based on the received NW-trained AI model information.

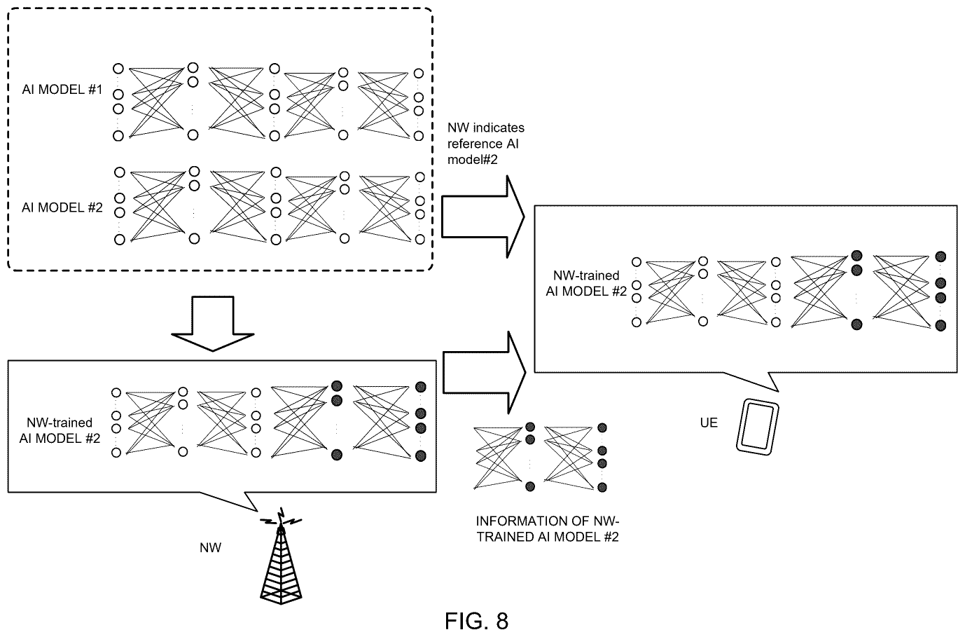

FIG. 8 is a diagram to show an example of indication of an AI model according to the second embodiment. In the present example, reference AI models #1 and #2 are defined in a standard. The NW trains reference AI model #2 to derive NW-trained AI model #2.

The NW notifies the UE of AI model information indicating reference AI model #2, and information of NW-trained AI model #2 (for example, information of the updated difference). The UE receiving these information can determine NW-trained AI model #2 for reference AI model #2 in consideration of the updated difference information.

The UE may use, for inference, the NW-trained AI model without change based on the received NW-trained AI model information.

The UE may train the NW-trained AI model, based on the received NW-trained AI model information.

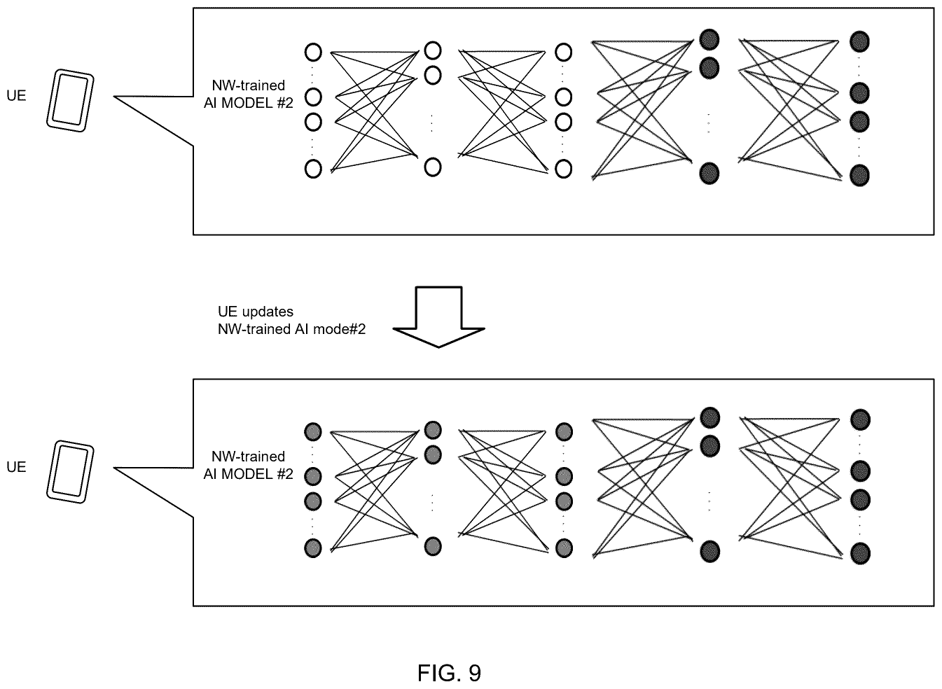

FIG. 9 is a diagram to show an example of the update of the AI model according to the second embodiment. In the present example, assume that similar to FIG. 8, the UE determines NW-trained AI model #2. The UE may further update NW-trained AI model #2. For example, the UE may update the same layers (first three layers shown in the figured) in NW-trained AI model #2 as those in original reference AI model #2, based on the data set owned by the UE itself.

The UE need not update, in the training, parameters (for example, a layer, a weight) to be frozen for training which are obtained from the NW-trained AI model information. The UE may update, in the training, parameters to be updated which are obtained from the NW-trained AI model information.

The UE may perform the training by using parameters to be the initial parameters (to be used as the initial parameters) for training which are obtained from the NW-trained AI model information.

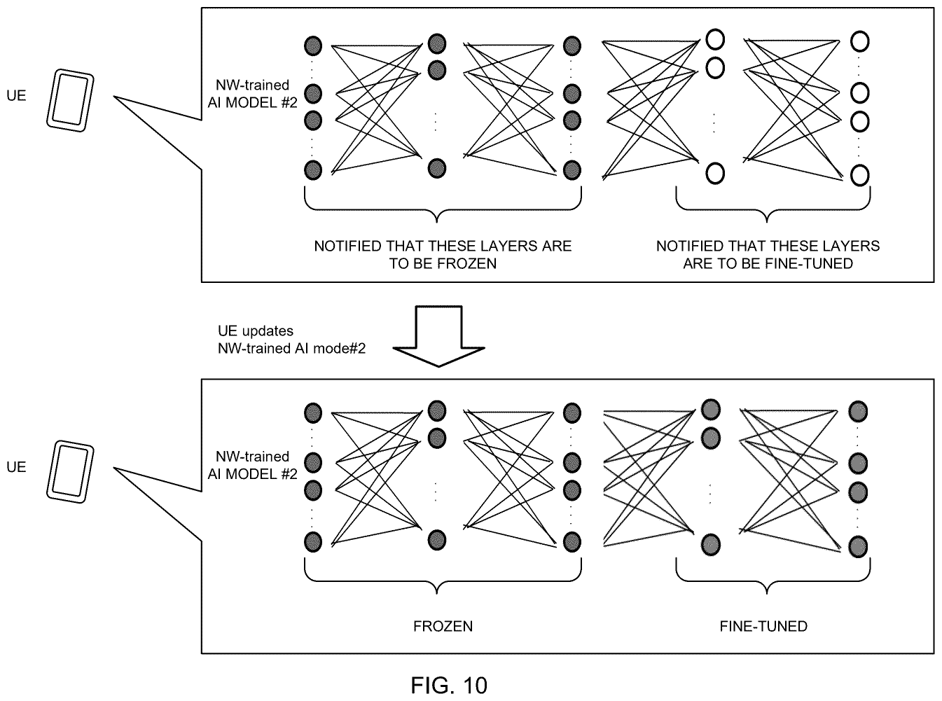

FIG. 10 is a diagram to show an example of the update of the AI model according to the second embodiment. In the present example, the UE is indicated to update NW-trained AI model #2 from the NW. However, the indication includes information indicating that first three layers are to be frozen, and last two layers are to be fine-tuned. The UE may derive updated AI model #2 in which the first three layers of NW-trained AI model #2 are frozen and the last two layers are fin-tuned based on the indication.

According to the second embodiment described above, the NW-trained AI model can be appropriately used in the UE.

### Third Embodiment

A third embodiment relates to controlling the use of an AI model trained by a UE (hereinafter, also referred to as a UE-trained AI model).

The UE may train a reference AI model/NW-trained AI model to derive a UE-trained AI model.

The UE may transmit AI model information related to the UE-trained AI model (hereinafter, also referred to as UE-trained AI model information) to an NW by using physical layer signaling (for example, UCI), higher layer signaling (for example, RRC signaling, MAC CE), a specific signal/channel, or a combination of these.

The UE-trained AI model information may include, instead of in addition to the AI model information already described, information of any or a combination of the following:
(an index of) the reference AI model/NW-trained AI model that is the base of the UE-trained AI model, and
information of a difference of the UE-trained AI model from the reference AI model/NW-trained AI model.

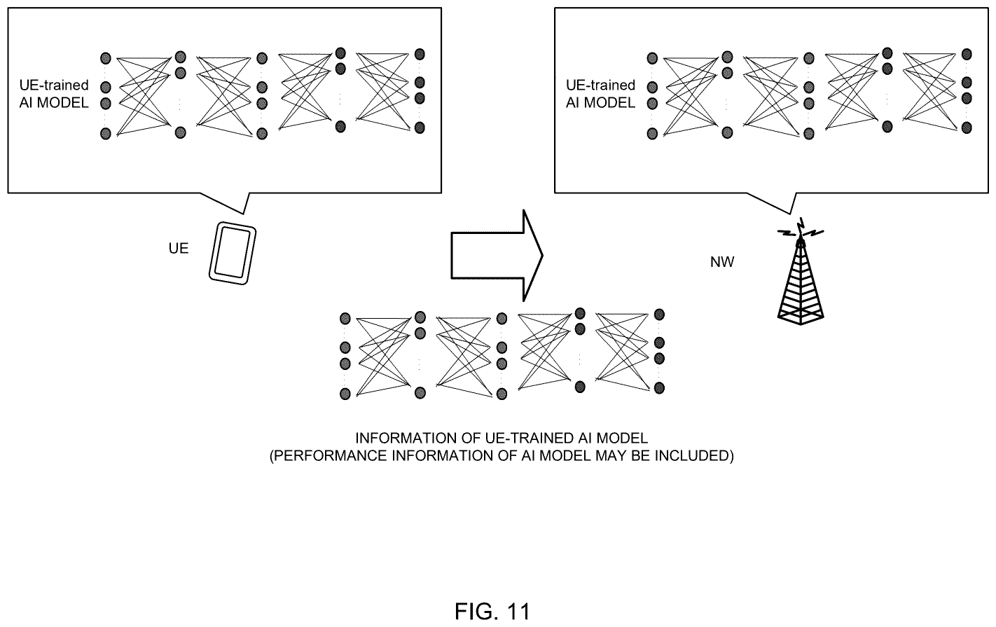

FIG. 11 is a diagram to show an example of indication of an AI model according to the third embodiment. In the present example, the UE derives the UE-trained AI model. The UE transmits the UE-trained AI model information (which may include performance information of the AI model) to the NW. The NW may apply the UE-trained AI model indicated by the relevant information.

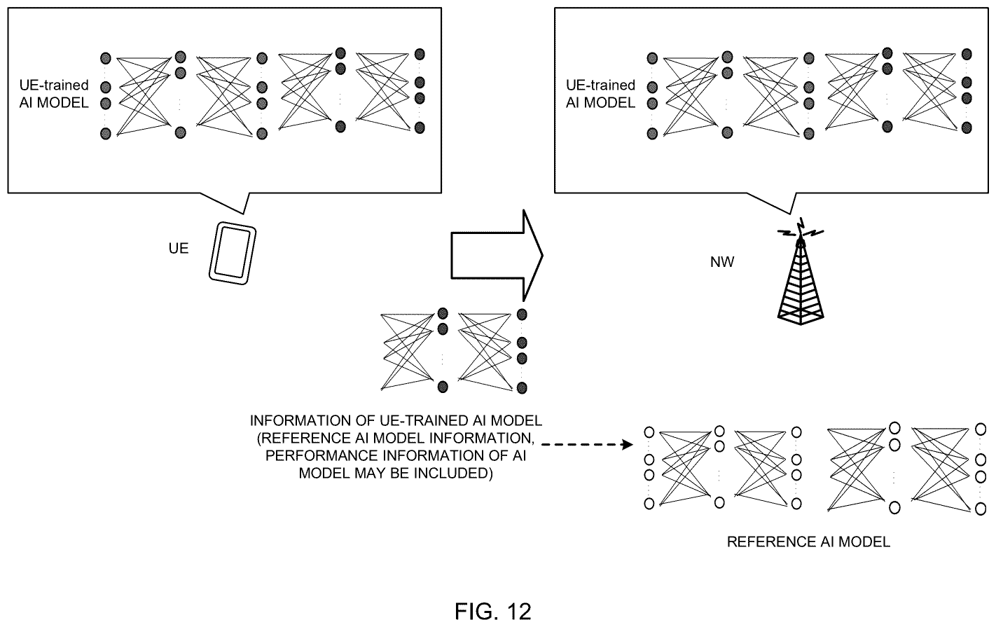

FIG. 12 is a diagram to show an example of indication of the AI model according to the third embodiment. In the present example, the UE derives the UE-trained AI model from a reference AI model. A difference between these models corresponds to partial layers which are colored in the figure. The UE transmits the UE-trained AI model information to the NW. The relevant information may include the above reference AI model information and the above difference information (and the performance information of the AI model). The NW can determine the UE-trained AI model for the reference AI model indicated by the information in consideration of the updated difference information.

The UE may report information (for example, included in the UE-trained AI model information) related to which weight/layer is updated.

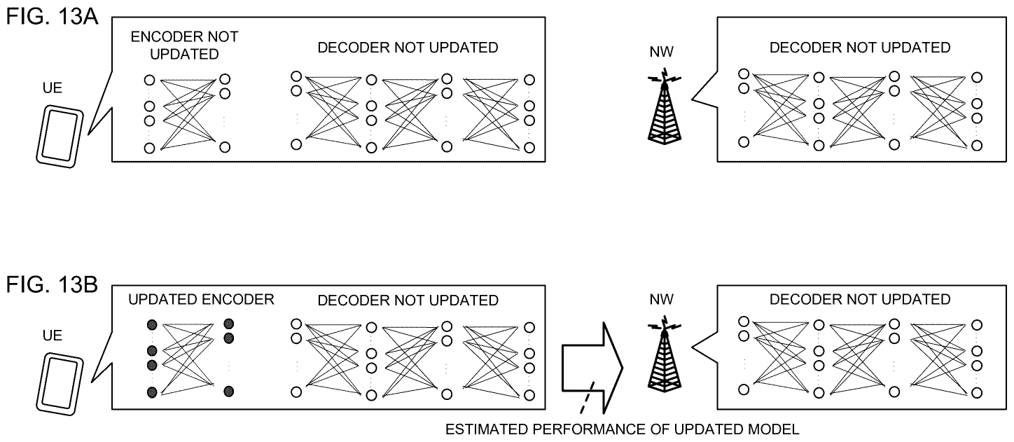

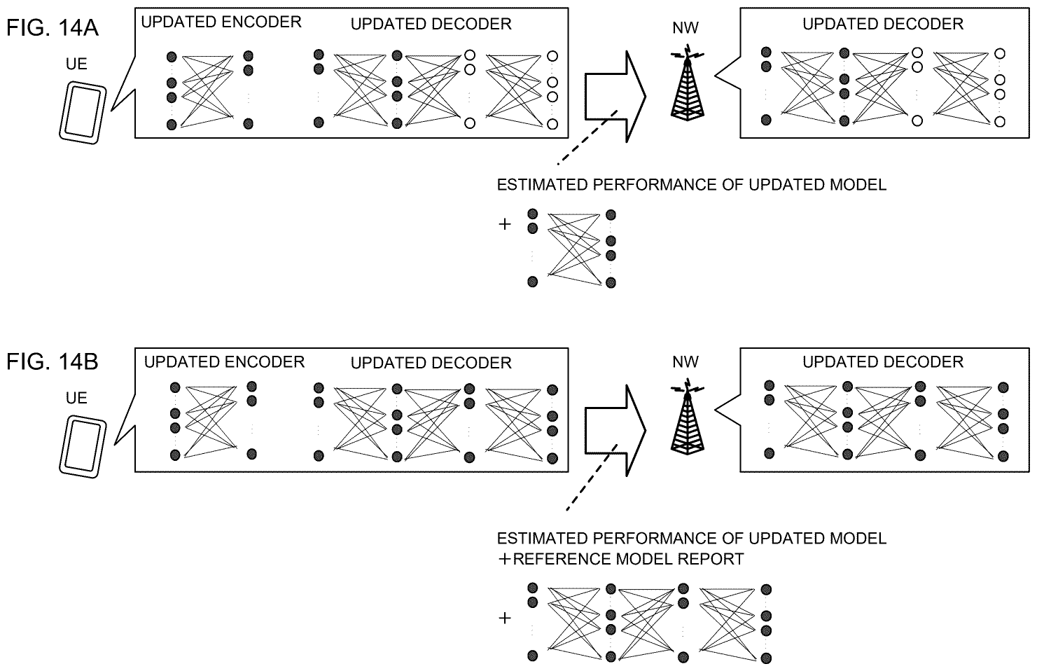

FIGS. 13A and 13B and FIGS. 14A and 14B are diagrams to show examples of the UE-trained AI model information according to the third embodiment. In the present example, the UE trains the autoencoder (encoder/decoder), and reports the UE-trained AI model information about the decoder to the NW as needed.

FIG. 13A corresponds to a case where the UE does not train an AI model, and neither the encoder nor the decoder is updated, thus the UE-trained AI model information is not transmitted to the NW.

FIG. 13B corresponds to a case where the encoder only is updated. The UE need not include decoder information in the UE-trained AI model information, but may transmit the UE-trained AI model information including, for example, information related to estimated performance of the updated model. The case of FIG. 13B may be used in a case where change in statistical nature of input can be sufficiently dealt with only by modification of the encoder.

FIG. 14A corresponds to a case where the encoder and part of the decoder are updated. The UE may transmit the UE-trained AI model information including the decoder information (information of the updated part), for example, information related to estimated performance of the updated model. The case of FIG. 14A may be used in a case where change in statistical nature of input can be sufficiently dealt with only by relatively minor modification of the decoder.

FIG. 14B corresponds to a case where the encoder and entire of the decoder are updated. The UE may transmit the UE-trained AI model information including the decoder information, for example, information related to estimated performance of the updated model, a reference model report, and the like. The case of FIG. 14B may be used in a case where relatively major modification of the decoder is required for change in statistical nature of input.

From a viewpoint of the communication overhead reduction, the UE preferably applies a report of FIG. 13B in a case that the performance is sufficient in FIG. 13B, a report of FIG. 14A in a case that the performance is sufficient in FIG. 14A, and a report of FIG. 14B in a case that the performance is insufficient in FIG. 14A. In this manner, the UE may dynamically control the communication overhead involved by the notification of the AI model.

### {Distributed Type Learning}

The transmission of the UE-trained AI model information according to the third embodiment may be used for distributed type learning performed by using a server and a number of clients in the NW. In this case, the UE-trained AI model information may be referred to as client-trained AI model information.

The distributed type learning may be federated learning including at least one of steps described below:
each of the clients reports a resource of computation to the server,
the server provides a global AI model to selected clients,
each of the selected clients trains a local AI model, based on the global AI model and data owned by the client itself,
each of the selected clients reports parameters for the local AI model to the server,
the server couples the reported local AI models to update the global AI model, and provides the updated global AI model to one or more clients (for example, all of the clients).

At least some of the above steps may be repeatedly performed.

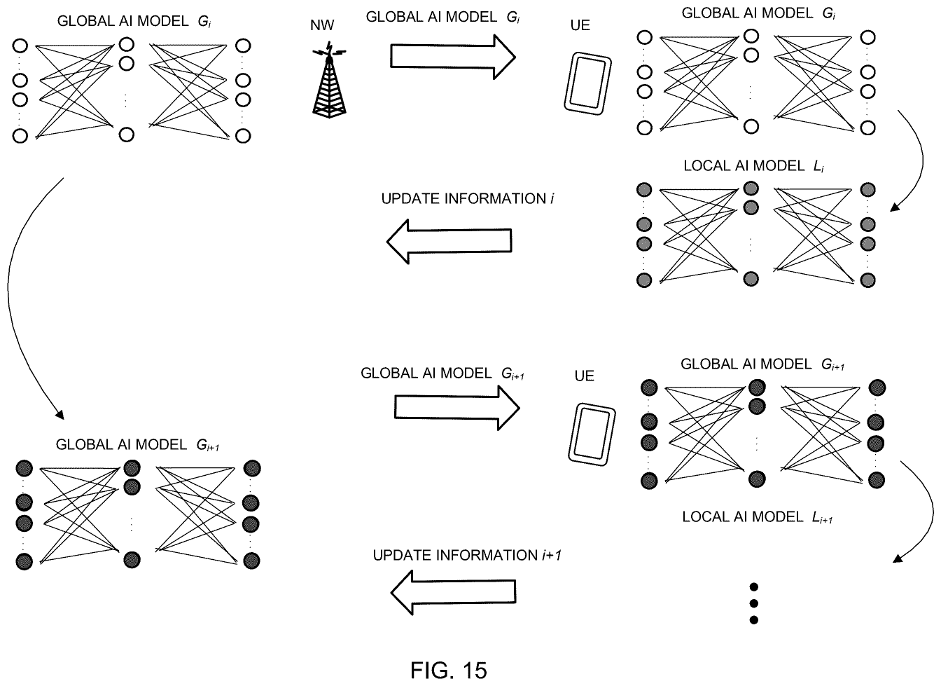

FIG. 15 is a diagram to show an example of exchange of the AI model information for the federated learning.

For example, in the i-th (i represents an integer) repetition, the server (the NW in the present example) transmits AI model information of a global AI model Gᵢ to the client (the UE in the present example). The client updates the global AI model Gᵢ, based on a data set owned by the client itself to obtain a local AI model Lᵢ. The client feeds back (reports) update information i related to the local AI model Lᵢ to the server.

The server updates the global AI model Gᵢ, based on the update information i from one or more clients to obtain a global AI model Gᵢ₊₁. In this manner, the federated learning may be proceeded.

The NW may transmit the AI model information related to the global AI model to the UE. The AI model information may be referred to as global AI model information. The global AI model information may include the reference AI model information.

The global AI model information may include information only on any or a combination of the following:
(an index of) the reference AI model that is the base of the global AI model,
(an index of) the global AI model,
information of a difference of the global AI model from the reference AI model.

The AI model information of the global AI model Gᵢ₊₁ may include information of a difference of the global AI model Gᵢ from the AI model (information).

The update information i may include a model ID for the global AI model/local AI model, may include the information of a difference of the global AI model Gᵢ from the AI model (information), or may correspond to updated AI model information which is described later in a fourth embodiment.

The UE may report intermediate information of the local AI model Lᵢ (for example, a gradient, a feature, and the like) in or instead of the update information i.

Note that the server may be a gNB/OAM/LMF/UE, and the client may be a UE/gNB. For example, in the case that the UE is the client, there is an advantage that a large amount of data for training is not required to be transmitted to the gNB. For example, in the case that the gNB is the client, there is an advantage that a large amount of data for training is not required to be transmitted to the OAM/LMF.

Note that in the present disclosure, a server, an NW, a gNB, an OAM, an LMF, and a UE may be interchangeably interpreted. In the present disclosure, a client, an NW, a UE, and a gNB may be interchangeably interpreted. In the present disclosure, a gNB/UE may be interpreted as an apparatus in another network/core network.

The client (for example, the UE) may report information for a resource for AI model training in the current repetition (hereinafter, also referred to as resource information) to the server (for example, the gNB). The resource information described above may include information related to at least one of the following:
capabilities related to the AI model training (for example, the resource of computation),
information of an available data set (for example, a structure/type/format/amount of the data set), and
information related to the client (for example, a status of the UE).

The resource of computation describe above may indicate, for example, at least one of available floating-point operations per second (FLOPS), Central Processing Unit (CPU)/Graphics Processing Unit (GPU) performance, an available memory amount, and the like.

The information related to the client may include information related to at least one of the following:
information related to a type of the client (device) (for example, a model name/model number of the device, a name/model number of a communication chip, and the like),
an estimated result/quality (for example, a block error rate (BLER)/CQI/RSRP/RSRQ/SINR),
a client will for processing the training (for example, whether one or more clients prepare for processing the training of the AI model),
a data remaining amount which the client can exchange (for example, a data amount which the client can exchange) with the server, and
a battery power remaining amount.

According to the third embodiment described above, the UE-trained AI model can be appropriately used.

### Fourth Embodiment

The fourth embodiment relates to information of a difference of a given AI model from another AI model (information of a difference of the other AI model with respect to the given AI model). The information of the difference may be referred to as updated AI model information.

The updated AI model information may be used as, for example, at least one piece of the following information already described:
information of a difference of an updated AI model from a pre-updated AI model,
information of a difference of the NW-trained AI model from the reference AI model, and
information of a difference of the UE-trained AI model from the reference AI model/NW-trained AI model.

The updated AI model information may include weight information represented by an absolute value, or weight information represented by a difference value of the updated AI model from the pre-updated AI model.

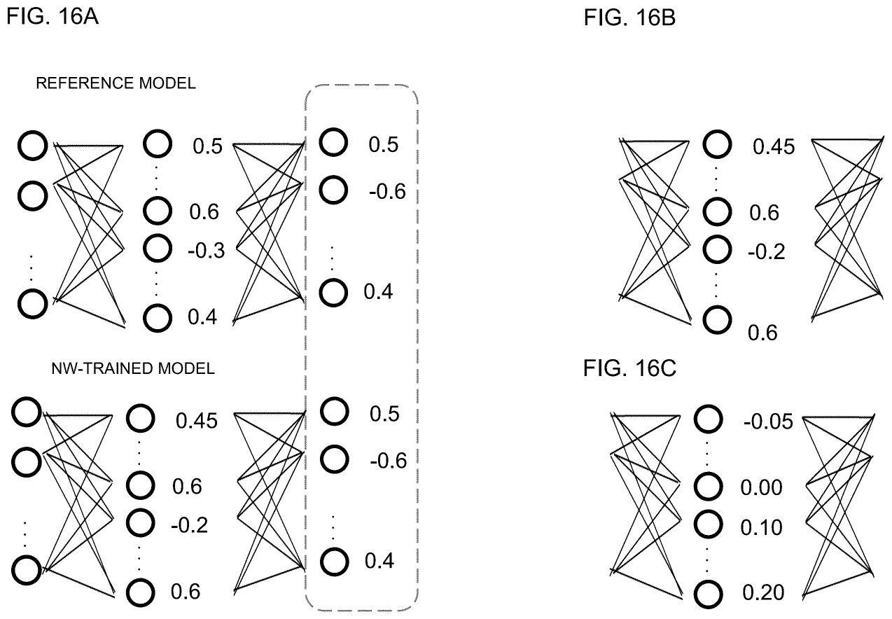

FIGS. 16A to 16C are diagrams to show an example of the updated AI model information. The present example shows the updated AI model information in a case that the NW-trained AI model is trained from the reference model shown in FIG. 16A.

FIG. 16B shows the weight information represented by an absolute value included in the updated AI model information. In the present example, the last layer is not updated, so may not be reported. The UE need not expect to report/receive the AI model information not updated.

FIG. 16C shows the weight information represented by a difference value included in the updated AI model information. The difference value is expected to be basically smaller than an absolute value, and thus, an information amount can be expected to be reduced. If the information amount in FIG. 16C is the same as in FIG. 16B, a granularity of each piece of the weight information can be decreased, and thus, more detailed model representation can be achieved.

Note that in a case that the reference model information also includes information of the structure of the AI model, the updated AI model information need not include the information of the structure of the AI model. This is because a UE and a base station can judge the AI model, based on the same structure of the AI model by exchanging only the weight information.

According to the fourth embodiment described above, signaling overhead for AI model deployment can be appropriately reduced.

### Fifth Embodiment

A fifth embodiment relates to knowledge distillation.

In the knowledge distillation, a single large model/a plurality of ensembled models with good prediction accuracy are prepared as a teacher model, and knowledge the teacher model has is used for learning of a student model which is light weight and easy to deploy. The student model obtained by distillation is expected to be a model having an accuracy comparable with the teacher model and a lighter weight.

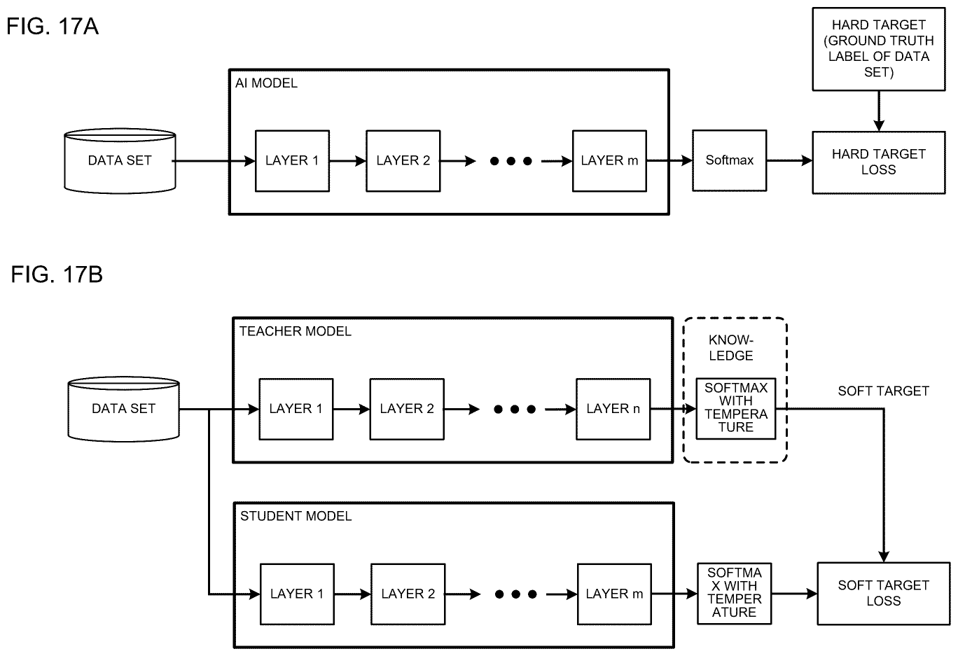

FIGS. 17A and 17B are diagrams to show an example of learning using the knowledge distillation. In normal learning, an AI model is trained such that a data set (leaning data) is input and an obtained output (output from a layer m) is closer to a ground truth.

Note that the output from the layer m, a variable/value before applying one or more functions (for example, sigmoid function/softmax function) may be referred to as logits, and a variable/value after applying the one or more functions may be referred to as a probs. A sum of probs for all possible classes of the ground truth is 1.

In the normal leaning shown in FIG. 17A, the learning is performed such that a loss of the probs and a hard target (also referred to as a hard target loss, an inference reference loss, and the like) is smaller, the hard target being a ground truth label of the learning data.

On the other hand, in learning using the knowledge distillation shown in FIG. 17B, the learning is performed such that a loss of student probs and a soft target (also referred to as a soft target loss, distillation loss, and the like) is smaller, the soft target being a teacher output (probs). In the knowledge distillation, the one or more functions described above may be, for example, a softmax function with temperature. Note that the soft target may correspond to information related to a probability with which an input belongs to each class.

When a teacher model logits is represented by v, the probs is represented by p, a student model logits is represented by z, and the probs is represented by q, a probs pᵢ for a class i of a teacher model when a temperature is T may be found by using pᵢ=exp(vᵢ/T)/Σⱼexp(v/T), and a probs qᵢ for the class i of the teacher model when the temperature parameter is T may be found by using qᵢ=exp(zᵢ/T)/Σⱼexp(z/T).

The soft target loss may be found by taking a cross entropy, based on the teacher model pᵢ and the student model pᵢ, and, for example, soft target loss=−Σᵢpᵢ log(qᵢ) may be found.

Note that the hard target loss may be found based on qᵢ for T=1.

In the fifth embodiment, a UE may receive AI model information related to the student model (hereinafter, also referred to as student model information). The UE may use a student model indicated based on the received student model information to obtain an output (train the student model), and report information related to the output to an NW. This step may be referred to as re-training of the student model.

The student model information may include, instead of or in addition to the AI model information already described, any or combinations of the following:
(an index of) the student model,
(an index of) the teacher model,
information related to a data set used to calculate the teacher model/student model,
a value of the soft target of the teacher model/student model,
a value of an output from a certain layer of the teacher model/student model,
a value of a loss function of the teacher model/student model,
a value of the soft target for the teacher model/student model,
a value of an output from a certain layer of the teacher model/student model, and
a value of a loss function for the teacher model/student model.

Note that the information related to a data set may correspond to, for example, at least one of a batch of data, an index indicating the data set (or data), the data set (or data) itself, and the like. The information of the value of the loss function described above may include information of one or both of the soft target loss and the hard target loss.

The UE may transmit information related to a student model to re-train (hereinafter, also referred to as re-trained student model information) to the NW by using physical layer signaling (for example, UCI), higher layer signaling (for example, RRC signaling, MAC CE), a specific signal/channel, or a combination of these. The re-trained student model information may include, instead of or in addition to the AI model information already described, any or combinations of the following:
(an index of) the student model that is the base of the re-trained student model, and
information related to knowledge of the re-trained student model (for example, a soft target, an output from a layer),
information related to a data set used for re-training,
intermediate information of the re-trained student model (for example, a gradient, a feature, and the like), and
information related to a hard target loss for the re-trained student model.

The information related to a data set described above may include information related to contents of data included in the data set.

The NW may further update the student model, based on a soft target specified by information related to the student model to be re-trained, and a soft target of teacher data. Note that the re-training may be referred also including this update by the NW.

Note that in a case that the UE receives information related to the teacher model (hereinafter, also referred to as teacher model information) from the NW, the UE may use the teacher model information for re-training the student model described above.

According to the fifth embodiment, even in a case where the UE uses a light weight student model in consideration of a computation capability, the UE reports the re-trained student model information to the NW, which enables the NW to anew perform the knowledge distillation to generate a more accurate/lighter weight student model.

### <Supplement>

Any notification from an NW to a UE in the above-described embodiments may be performed by using physical layer signaling (for example, DCI), higher layer signaling (for example, RRC signaling, MAC CE), a specific signal/channel (for example, PDCCH, PDSCH, reference signal), or a combination of these.

In a case where the notification described above is performed by the MAC CE, the MAC CE may be identified by a new logical channel ID (LCID) being included in a MAC sub-header.

In a case where the notification described above is performed by the DCI, the notification described above may be performed by use of a specific field of the DCI, a radio network temporary identifier (RNTI) used to scramble a cyclic redundancy check (CRC) bit attached to the DCI, a format of the DCI, and the like.

Any notification from an NW to a UE in the above-described embodiments may be periodically, semi-persistently, or aperiodically.

An encoder/decoder in the above-described embodiments may be interpreted as an AI model deployed in a UE/base station. That is, the present disclosure may be applied to not only the case where the autoencoder is used but also a case where an arbitrary model is used for inference. What is compressed by a UE/base station in the present disclosure by using the encoder is not limited to the CSI (or a channel/precoding matrix) but may be arbitrary information.

At least one of the above-described embodiments may be applied only to a UE that has reported specific UE capabilities or that supports the specific UE capabilities.

The specific UE capabilities may indicate at least one of the following:
supporting specific processing/operation/control/information for at least one of the above-described embodiments,
supporting acquiring/reporting of the channel state information (for example, LOS, NLOS, location information),
maximum FLOPs of the AI model the UE can deploy,
the maximum number of parameters for the AI model the UE can deploy,
a reference model the UE supports,
a layer/algorithm/function the UE supports,
computation capability, and
data collection capability.

The specific UE capabilities described above may be a capability applied across all frequencies (commonly regardless of frequency), a capability per frequency (for example, a cell, a band, a BWP), a capability per frequency range (for example, Frequency Range 1 (FR1), FR2, FR3, FR4, FR5, FR2-1, FR2-2), or a capability per subcarrier spacing (SCS).

The specific UE capabilities described above may be a capability applied across all duplex modes (commonly regardless of duplex mode), or a capability per duplex mode (for example, time division duplex (TDD), frequency division duplex (FDD)).

At least one of the above-described embodiments may be applied to a case where the UE is configured with specific information associated with the above-described embodiments by higher layer signaling. For example, the specific information may be information indicating enabling of a use of an AI model, any RRC parameter for a specific release (for example, Rel. 18), or the like.

In a case where the UE does not support at least one of the specific UE capabilities described above or is not configured with the specific information, the UE may apply, for example, Rel-15/16 operation.

Note that at least one of the above-described embodiments may be used for (compression of) UE-base station information transmission except for the CSI feedback. For example, the UE may (generate by using the encoder, for example, and) report information related to a location (or positioning)/information related to location estimation in the location management function (LMF) to the network in accordance with at least one of the above-described embodiments. The information may be information of a channel impulse response (CIR) per subband/per antenna port.

Reporting this information allows the base station to estimate the location of the UE without reporting an angle/time difference of a received signal.

### (Supplementary Notes)

The following invention is supplemented for one embodiment of the present disclosure.

### [Supplementary Note 1]

A terminal including
a receiving section that receives network (NW)-trained model information related to a model trained by a network (NW-trained model) and reference model information related to a reference model that is a base of the NW-trained model, and
a control section that judges the NW-trained model, based on the NW-trained model information and the reference model information.

### [Supplementary Note 2]

The terminal according to supplementary note 1, wherein the NW-trained model information indicates a difference between the NW-trained model and the reference model, and the reference model information indicates an index related to the reference model.

### [Supplementary Note 3]

The terminal according to supplementary note 1 or 2, wherein the control section further trains the NW-trained model.

### [Supplementary Note 4]

The terminal according to any one of supplementary notes 1 to 3, wherein
the NW-trained model information includes information of a parameter to be frozen for training, and
the control section further trains the NW-trained model with the parameter being not updated.

### (Supplementary Notes)

The following invention is supplemented for one embodiment of the present disclosure.

### [Supplementary Note 1]

A terminal including
a receiving section that receives network (NW)-trained model information related to a model trained by a network (NW-trained model) or reference model information related to a reference model that is a base of the NW-trained model,
a control section that further trains a model judged based on the NW-trained model information or the reference model information, and
a transmitting section that transmits information related to the trained model.

### [Supplementary Note 2]

The terminal according to supplementary note 1, wherein the information related to the trained model includes information related to which weight or layer is updated.

### [Supplementary Note 3]

The terminal according to supplementary note 1 or 2, wherein the information related to the trained model includes update information of a global model in federated learning.

### [Supplementary Note 4]

The terminal according to any one of supplementary notes 1 to 3, wherein the transmitting section transmits information for a resource for model training in a current repetition in federated learning.

### (Supplementary Notes)

The following invention is supplemented for one embodiment of the present disclosure.

### [Supplementary Note 1]

A terminal including
a receiving section that receives student model information related to a student model in knowledge distillation, and
a transmitting section that transmits information related to an output based on the student model information.

### [Supplementary Note 2]

The terminal according to supplementary note 1, wherein the information related to an output includes information related to a soft target of the student model.

### [Supplementary Note 3]

The terminal according to supplementary note 1 or 2, wherein the student model information includes a value of a loss function.

### [Supplementary Note 4]

The terminal according to any one of supplementary notes 1 to 3, wherein the student model information includes information of one or both of a soft target loss and a hard target loss.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

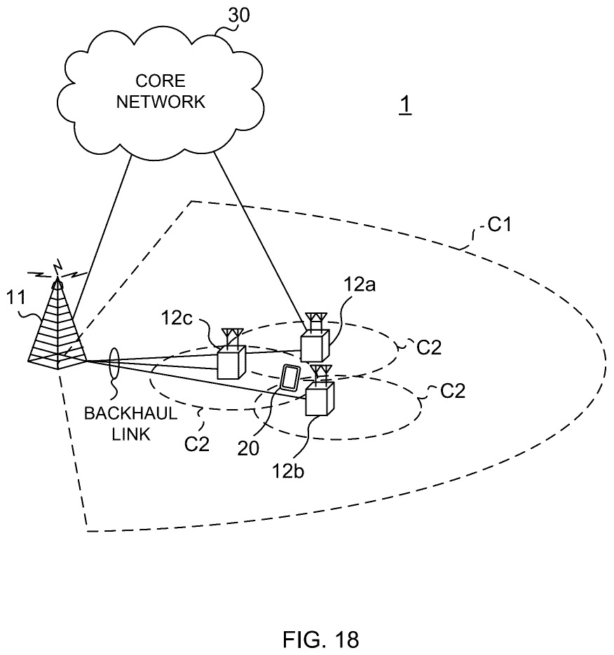

FIG. 18 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a reference signal for measurement (Sounding Reference Signal (SRS)), a demodulation reference signal (DMRS), and so on may be communicated as an uplink reference signal (UL-RS). Note that DMRS may be referred to as a “user terminal specific reference signal (UE-specific Reference Signal).”

### (Base Station)

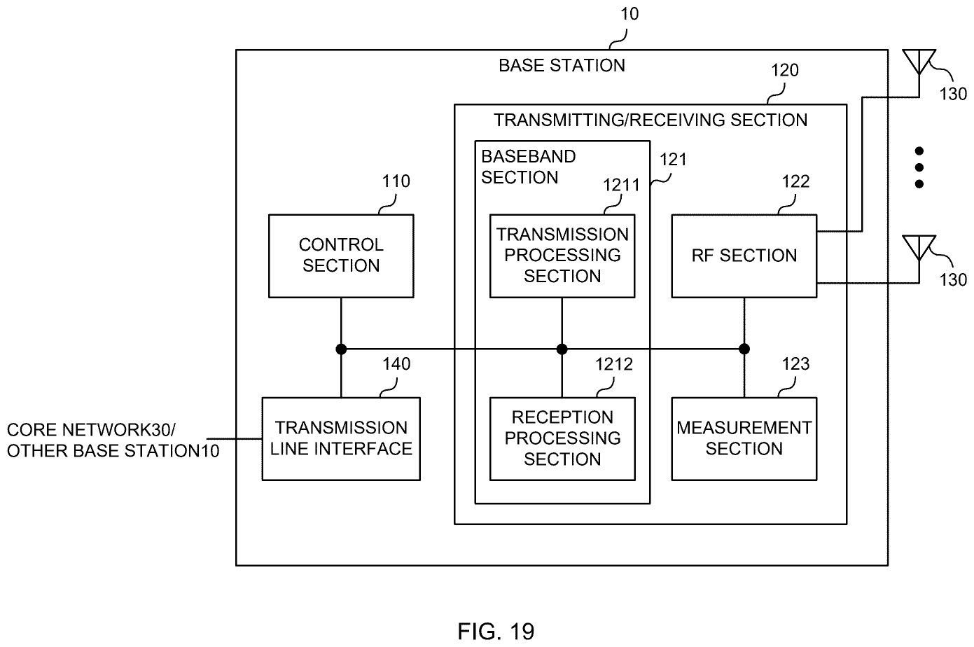

FIG. 19 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RPUM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the control section 110 may train the reference model. The transmitting/receiving section 120 may transmit the information related to the trained model and the reference model information related to the reference model, to the user terminal 20.

The transmitting/receiving section 120 may transmit the information related to the model trained based on the reference model information related to the reference model or the reference model, to the user terminal 20. The transmitting/receiving section 120 may receive the information related to the model further trained based on the reference model or the model.

The transmitting/receiving section 120 may transmit the student model information related to the student model in the knowledge distillation, to the user terminal 20. The transmitting/receiving section 120 may receive the information related to the output based on the student model information.

### (User Terminal)

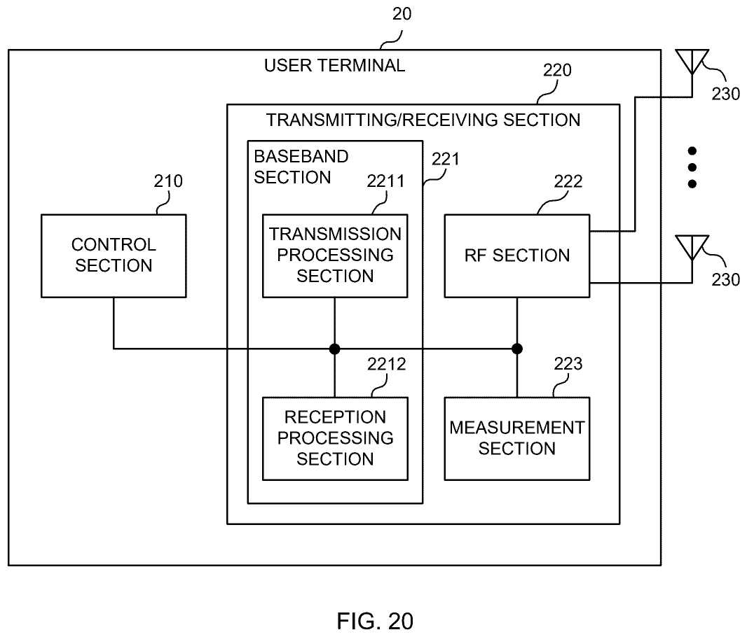

FIG. 20 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive network (NW)-trained model information related to a model trained by a network (NW-trained model) and reference model information related to a reference model that is a base of the NW-trained model. The control section 210 may judge the NW-trained model, based on the NW-trained model information and the reference model information.

The NW-trained model information may indicate a difference between the NW-trained model and the reference model, and the reference model information may indicate an index related to the reference model.

The control section 210 may further train the NW-trained model.

The NW-trained model information includes information of a parameter to be frozen for training, and the control section 210 further trains the NW-trained model, where the parameter need not be updated.

The transmitting/receiving section 220 may receive network (NW)-trained model information related to a model trained by a network (NW-trained model) or reference model information related to a reference model that is a base of the NW-trained model. The control section 210 may further train a model judged based on the NW-trained model information or the reference model information. The transmitting/receiving section 220 may transmit information related to the trained model.

The information related to the trained model may include information related to which weight or layer is updated.

The information related to the trained model may include update information of a global model in federated learning.

The transmitting section 220 may transmit information for a resource for model training in a current repetition in the federated learning.

The transmitting/receiving section 220 may receive the student model information related to the student model in the knowledge distillation. The transmitting/receiving section 220 may transmit the information related to the output based on the student model information.

The information related to the output may include information related to a soft target of the student model.

The student model information may include a value of a loss function.

The student model information may include information of one or both of a soft target loss and a hard target loss.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatus (for example, via wire, wireless, or the like) and using these plurality of apparatus. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

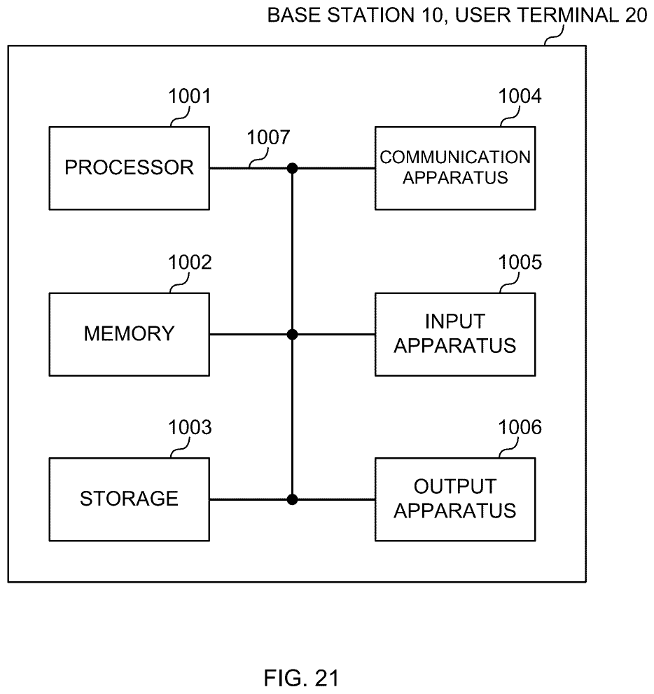

For example, a base station, a user terminal, and so on according to one embodiment of the present disclosure may function as a computer that executes the processes of the radio communication method of the present disclosure. FIG. 21 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform computations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAN), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP.”

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names assigned to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input/output may be stored in a specific location (for example, a memory) or may be managed by using a management table. The information, signals, and so on to be input/output can be overwritten, updated, or appended. The information, signals, and so on that are output may be deleted. The information, signals, and so on that are input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be notified using, for example, MAC control elements (MAC CEs).

Also, notification of given information (for example, notification of “X holds”) does not necessarily have to be notified explicitly, and can be notified implicitly (by, for example, not performing notification of this given information or performing notification of another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB, “an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, a base station transmitting information to a terminal may be interchangeably interpreted as the base station indicate control/operation base on the information to the terminal.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

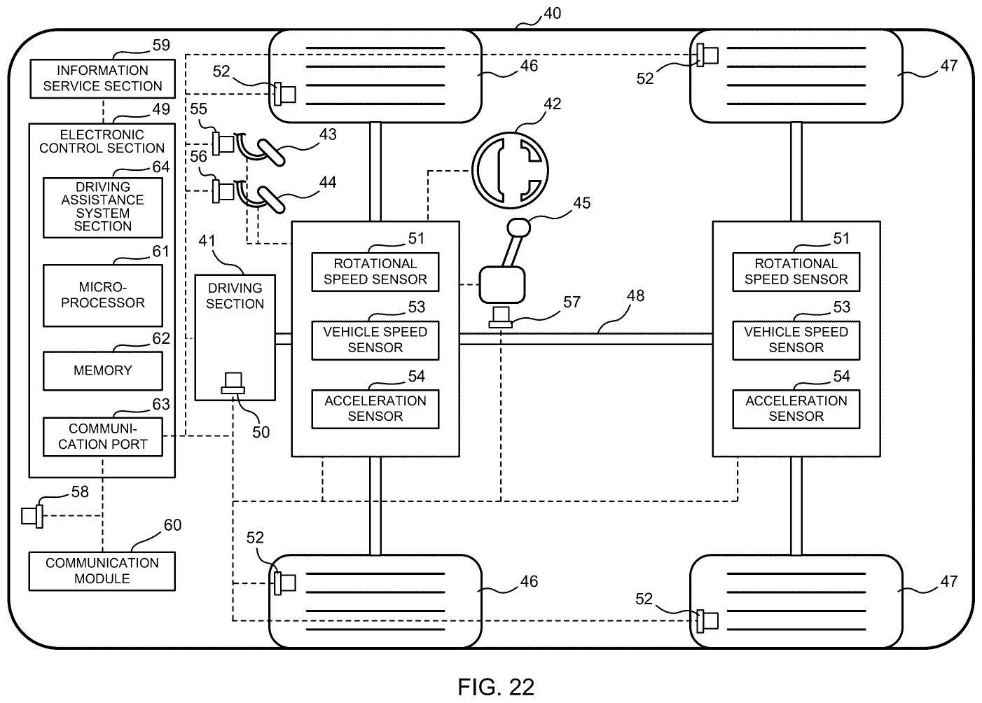

FIG. 22 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various information such as drive information, traffic information, and entertainment information, such as a car navigation system, an audio system, a speaker, a display, a television, and a radio, and one or more ECUs that control these devices. The information service section 59 provides various information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various information (traffic information, signal information, inter-vehicle distance information, and the like) transmitted from the external apparatus, and displays the various information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various information received from the external apparatus in the memory 62 that can be used by the microprocessor 61. Based on the information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG, where x is, for example, an integer or a decimal), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (M4B), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or less than,” “less than,” “more than,” “equal to,” and the like may be interchangeably interpreted. In the present disclosure, the words meaning “good,!” “bad, ““large, ““small, ““high, ““low, ““early,” “late,” and the like may be interchangeably interpreted (without distinction of positive, comparative, superlative). In the present disclosure, the words meaning “good,” “bad,” “large,” “small,!” “high,!” “low,!” “early,!” “late,!” and the like may be interchangeably interpreted as expressions of those with “ith” prefixed (without distinction of positive, comparative, superlative) (for example, “highest” may be interchangeably interpreted as “ith highest”).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives network (NW)-trained model information related to a model trained by a network (NW-trained model) and reference model information related to a reference model that is a base of the NW-trained model; and
a control section that judges the NW-trained model, based on the NW-trained model information and the reference model information.

2. The terminal according to claim 1, wherein
the NW-trained model information indicates a difference between the NW-trained model and the reference model, and the reference model information indicates an index related to the reference model.

3. The terminal according to claim 1, wherein
the control section further trains the NW-trained model.

4. The terminal according to claim 1, wherein
the NW-trained model information includes information of a parameter to be frozen for training, and
the control section further trains the NW-trained model with the parameter being not updated.

5. A radio communication method for a terminal, the radio communication method comprising:
receiving network (NW)-trained model information related to a model trained by a network (NW-trained model) and reference model information related to a reference model that is a base of the NW-trained model; and
judging the NW-trained model, based on the NW-trained model information and the reference model information.

6. A base station comprising:
a control section that trains a reference model; and
a transmitting section that transmits information related to the trained model and reference model information related to the reference model.
